(19) United States
(12) Patent Application Publication
(10) Pub. No.: US 2021/0181517 A1
(43) Pub. Date: Jun. 17, 2021

(54) Head-Mounted Display Device Configured with an Interchangeable External Battery

(71) Applicant: Robert Charles DeMaio, Sparks, NV (US)

(72) Inventor: Robert Charles DeMaio, Sparks, NV (US)

(21) Appl. No.: 17/186,204

(22) Filed: Feb. 26, 2021

Related U.S. Application Data
(63) Continuation-in-part of application No. 16/664,000, filed on Oct. 25, 2019.

(51) Int. Cl. G02B 27/01; G06F 1/16; H01M 10/04

(52) U.S. Cl. CPC G02B 27/0176; G06F 1/1635; G02B 2027/0178; H01M 10/0436; G06F 1/163

(57) ABSTRACT

A head-mounted display (HMD) computing device is adapted with a channel and a receptacle to which an external battery can removably connect for providing power to the HMD device. The receptacle and battery can adapt to one or more of a shape and form of a portion of the HMD device's housing to enhance the components' aesthetic appearance. The HMD device may have an internal and rechargeable battery that holds a charge and can feed off the externally connectable battery. As the external battery's power begins to deplete, the user can disconnect the external battery from the HMD device's receptacle and then connect another distinct external battery. The user can continue to attach differently and charged external batteries so that the HMD device can last all day without being placed into submission to receive a charge from some charging dock or USB (universal serial bus) cable.

### CROSS-REFERENCE TO RELATED APPLICATIONS

This Non-Provisional Utility patent application is a Continuation-in-Part (CIP) application that claims the benefit of and priority to U.S. Non-Provisional Utility patent application Ser. No. 16/664,000 filed Oct. 25, 2019, entitled “External Watch Battery and Charging Device,” the entire contents of which is hereby incorporated herein by reference.

### BACKGROUND

Modern head-mounted display (HMD) devices come equipped with numerous features, including locational tracking using a global positioning system (GPS), internet connectivity, communications capabilities (e.g., text, calls, etc.), web searching, and various multimedia playing functionality, among other features. While small form factor technology is available to implement a robust ecosystem of features on HMD devices akin to smartphone functionality and beyond, battery power can limit its practical life and hinder its widespread adoption, even with a robust set of features. Users may be forced to carry around a charger or otherwise limit their use to particular situations where there will be access to an outlet.

### SUMMARY

A head-mounted display (HMD) computing device is adapted with a channel and a receptacle to which an external battery can removably connect for providing power to the HMD device. The receptacle and battery can adapt to one or more of a shape and form of a portion of the HMD device's frame to enhance the components' aesthetic appearance. The HMD device may have an internal and rechargeable battery that holds a charge and can feed off the externally connectable battery. As the external battery's power begins to deplete, the user can disconnect the external battery from the HMD device's receptacle and then connect another distinct external battery. The user can continue to attach differently and charged external batteries so that the HMD device can last all day without being placed into submission to receive a charge from some charging dock or USB (universal serial bus) cable. Each external battery can come in different colors and designs to enable a user to customize their look for a given day, outfit, or occasion.

The external battery may connect to a channel positioned on the front section of the HMD device and at the top of the frame. At least two contact points, such as negative and positive contact points, may be placed inside the channel's receptacles, in which corresponding contact points are placed on the external battery to enable an electrical connection and an exchange of electrical energy. The channel's receptacles and the external battery may also be configured with a mechanical connection mechanism to secure the battery in place, such as a press-fit, tab and notch, magnetic mechanism, or any combination thereof.

Additionally, the rear section of the glasses' temples may be equipped with a connecting receptacle to which additional external batteries can connect. For example, the external battery's ends may connect to opposing side temple receptacles on the HMD device's rear section. The user may freely choose between using the front section's channel receptacles or the rear section's temple receptacles when using the external battery, or both. The user may, for example, keep a backup external battery connected to the temples' receptacles while also using a different external battery in the frame's front section channel. The ability to connect the external battery such that it stretches behind a user's head provides the added benefit of securing and preventing the HMD device from falling off during, for example, a daring or exciting scenario, like a roller coaster ride.

The ends of multiple external batteries may also be configured to connect, such that a string of external batteries can be together while connected to the HMD device's temple receptacles. When an external battery is not connected to the temples' receptacles, a cover may be used to protect the contact points. Extenders may also be attached to the respective temples' receptacles to accommodate larger-sized heads when an external battery is connected to the temples' receptacles. The extenders may be linear components that connect to a temple receptacle and likewise have a receptacle to connect to an external battery. In this scenario, the extender also functions as a conduit to transfer energy between the external battery and the HMD device.

The HMD device may also come with extendable wires tucked inside cavities on the temples' bottom surfaces. The extendable wires have a connecting port that can connect to and charge an earbud or other peripheral device. This way, the continued replacement of the external batteries on the HMD device can lead to virtually all-day use of the HMD device and accessory devices, such as the earbuds.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### BRIEF DESCRIPTION OF THE DRAWINGS

FIG. 1 shows an illustrative environment of a head-mounted display (HMD) device hosting an external battery;

FIG. 2 shows an illustrative representation of the external battery aligned with a channel within the HMD device's frame;

FIG. 3 shows an illustrative representation of the external battery inserted into the frame's channel;

FIG. 4 shows an illustrative representation of a second external battery aligned with receptacles on the temple ends;

FIG. 5 shows an illustrative representation of a temple end cover being removed;

FIG. 6 shows an illustrative representation of the HMD device hosting two external batteries simultaneously;

FIG. 7 shows an illustrative representation of a charging port tucked away inside a cavity on a bottom surface of the HMD device's temple;

FIG. 8 shows an illustrative representation of the charging port connected to an earbud;

FIG. 9 shows an illustrative representation of a detachable extender for the HMD device's temple;

FIG. 10 shows an illustrative representation of the extender aligned with the temple end receptacle for engagement;

FIG. 11 shows an illustrative representation of a layered architecture for the HMD device;

FIG. 12 shows an illustrative diagram of functions performed by a battery management application instantiated within the HMD device; and

FIG. 13 is a simplified block diagram of an illustrative computing system, such as the HMD device, that may be used in part to implement the present HMD device with an interchangeable external battery system.

Like reference numerals indicate like elements in the drawings. Elements are not drawn to scale unless otherwise indicated.

### DETAILED DESCRIPTION

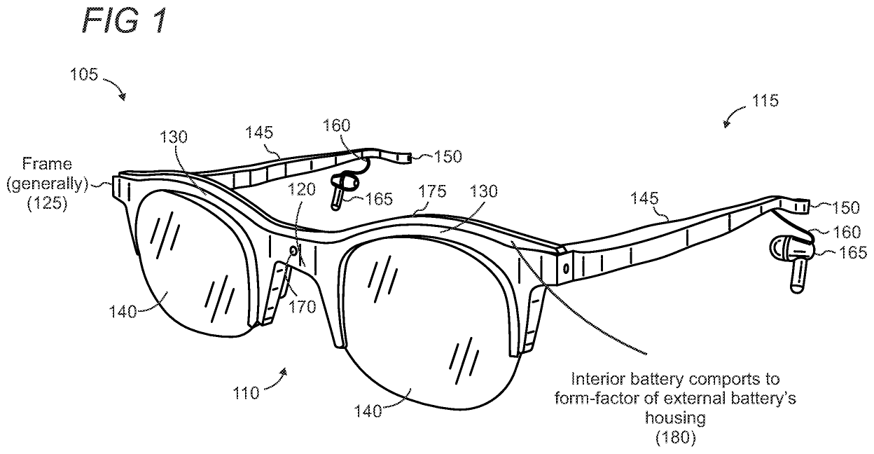

FIG. 1 shows an illustrative representation of a head-mounted display (HMD) device, which may provide virtual reality (VR) or augmented reality (AR) functions to a user. The HMD device includes a frame 125, which has a front section 110 and rear section 115. The front section includes a pair of lenses 140 secured to the left and right lens frames 130. The lenses operate stereoscopically; that is, a separate screen may show for each display 140. Since the HMD device has several substantially symmetrical components, its components may be referred to herein individually and collectively with a single reference numeral, such as the left and right lens frames 130. Put differently, unless stated otherwise, unique reference numerals are not used for symmetrical components since their structures and functions are mirrored.

The lens frames 130 are connected by a bridge 120, adapted to hang over the user's nose for stability. Left and right temples 145 generally extend perpendicularly from the front section's lens frames. The temples are used to hang over a user's ears so that the HMD device 105 can be worn. The temples lead to temple ends 150, which occupy an end portion of the temples. Wires 160 extend from a bottom surface of the temples, in which the wires can connect to standalone earbuds to, for example, provide charging or connectivity.

The HMD device also includes a camera 170 on the front section 110 of the frame 125, which can be controlled using voice-commands or other input (not shown) at the HMD device. The camera can capture a single picture or can capture videos. Captured images can, for example, be displayed on the user's lenses 140.

The various functionalities of the HMD device 105 can be powered by an internal battery (not shown) and an external battery 175, which protrudes upward from the front section 110 of the frame 125. The external battery has an outer housing that covers the interior battery. During the manufacturing process, the interior battery may be adapted to the form-factor of the outer housing, as representatively shown by numeral 180.

The external battery, in this implementation, extends across a substantial part of the HMD device's body—virtually from end-to-end. The external battery may, in other implementations, occupy a smaller portion of the HMD device's frame. The external battery can come in different colors, such as black, red, orange, green, multicolored, have graphic designs, or any combination thereof. Thus, the prevalence of the external battery's exposure dually-utilizes the battery as a functional and aesthetic piece of the HMD device.

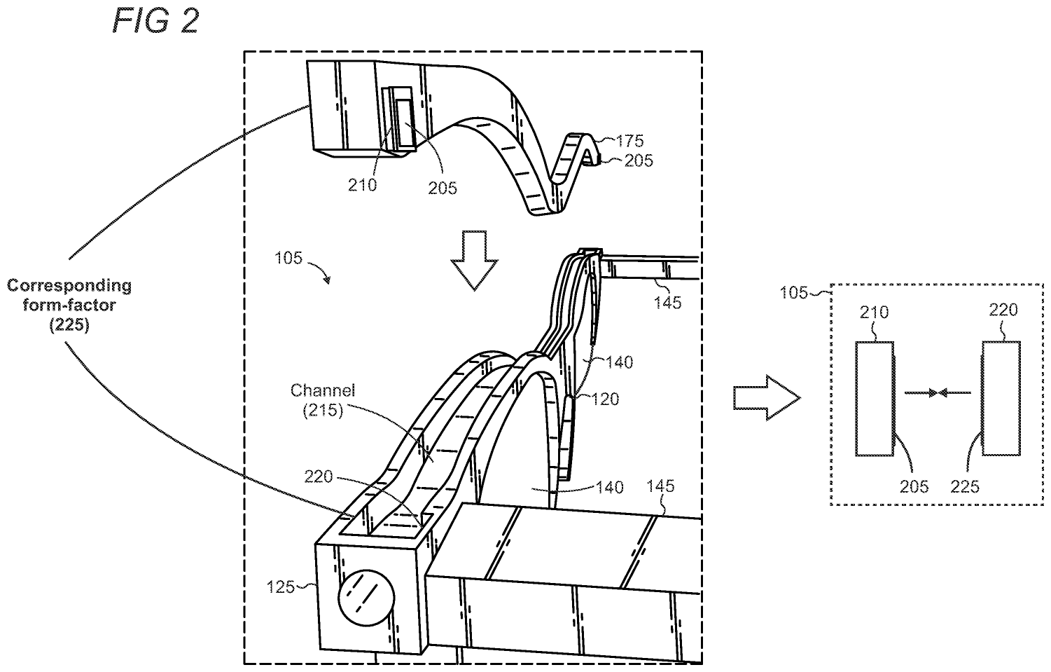

FIG. 2 shows an illustrative representation in which the external battery 175 is aligned with a channel 215 inside the HMD device's frame 125. The channel is essentially a cutout within the HMD device's frame to accommodate the external battery. The external battery's form-factor—including shape and size—at least partially corresponds to the channel's form-factor, as representatively illustrated by numeral 225. For example, the external battery dips at the bridge portion of the frame and then raises at the lens frames.

The external battery 175 includes connectors 210 on opposite sides thereof, which engage with corresponding receptacles 220 within the channel of the HMD device 105. The connection-receptacle implementation on the HMD device may be, for example, a press-fit, tab and notch, magnetic, or any combination thereof, among other connecting mechanisms. The connector 210 has a contact point 205 on an outside surface thereof which, when the battery is engaged with the channel, touches a corresponding contact point 225 within the receptacle 220. The box on the right side of FIG. 2 provides a simplistic diagram of the two contact points aligned with each other and set for the connection. The contact points may be comprised of some metal, such as copper, aluminum, and the like, to facilitate the transfer of power from the external battery to the HMD device. The contact points may be negatively or positively charged. In other implementations, other external or peripheral devices that connect inside channel 220 may exchange data (e.g., multimedia, documents) with the HMD device.

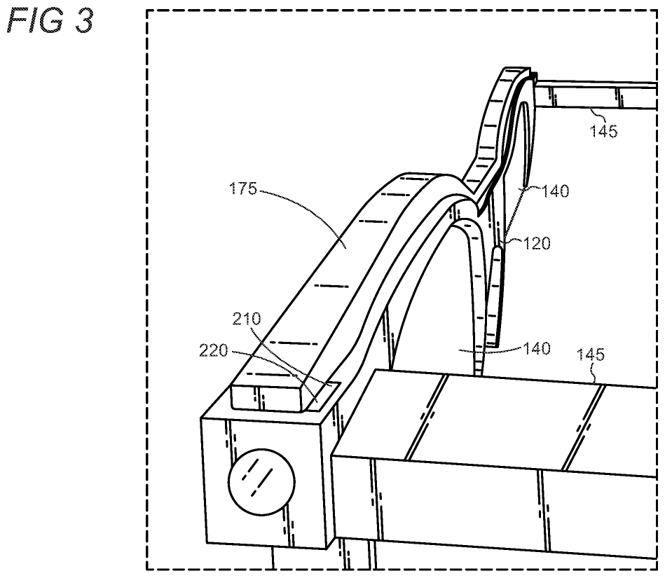

FIG. 3 shows an illustrative representation in which the external battery 175 has engaged and is secured to the HMD device's channel 215 (FIG. 2). The connectors 210 have engaged with the channel's receptacles 220, and the contact points are now touching to enable the exchange of power.

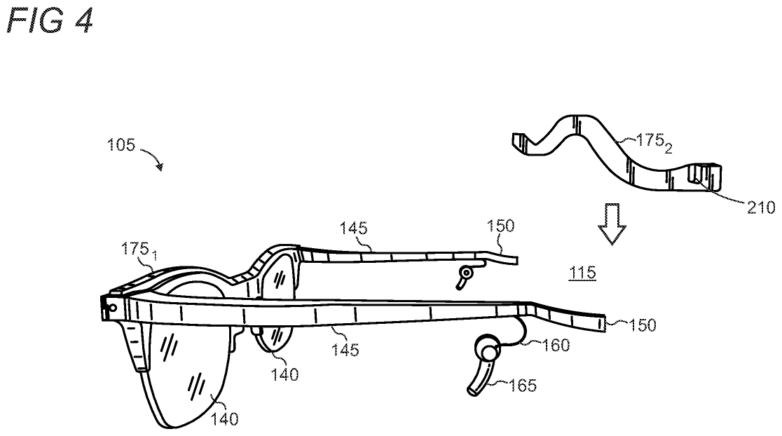

FIG. 4 shows an illustrative representation in which a second external battery 175, which likewise has a connector 210 and contact point 205, is aligned with a rear section 115 of the HMD device 105. The second external battery may be configured similarly to the external battery 175 described above. The second external battery is aligned with the temple ends 150 for placement. Therefore, the HMD device is configured with two distinct locations for external batteries.

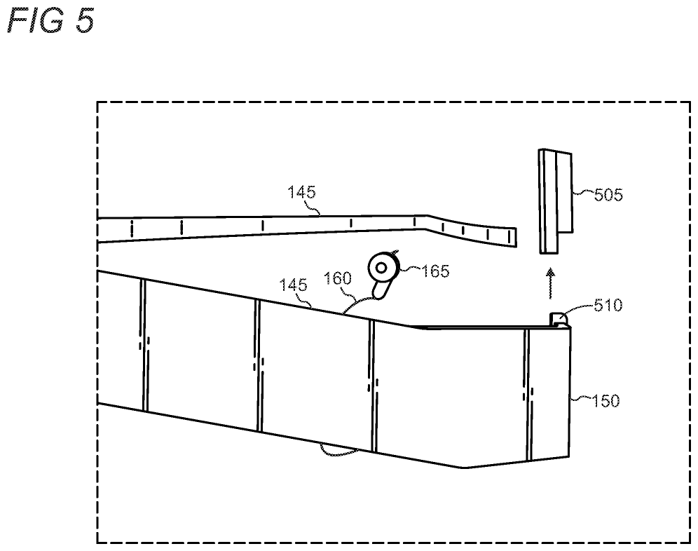

FIG. 5 shows an illustrative representation in which a cover 505 within the temple receptacles 510 on the left temple 145 is released. The covers are in place to protect the receptacles, contact points, and any exposed electronic circuitry from outside exposure (e.g., the weather). The covers can be removed when, for example, the user wishes to connect a peripheral device, such as the external battery 175. The covers can be stored away for later use. The temple receptacle 510 may be configured similarly to receptacle 220 on channel 215. The temple receptacle includes a press-fit, tab and notch, magnetic connection, among other connecting mechanisms, and can include a contact point that enables the exchange of data or power.

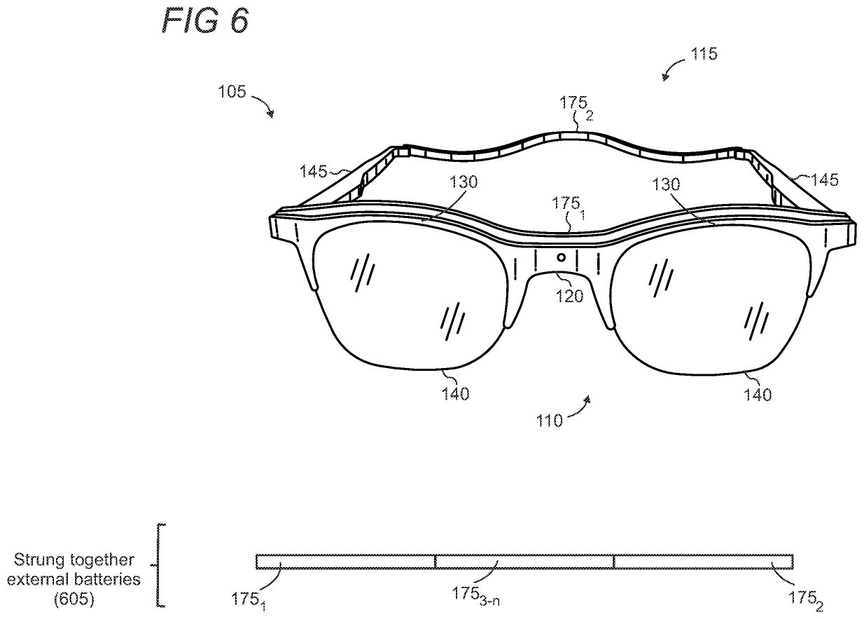

FIG. 6 shows an illustrative representation in which the second external battery 175 is connected to the temple receptacles 510 while another external battery is connected to the frame's front channel 215 (FIG. 2). The configuration and purpose of the dual-battery connections may change based on the implementation. For example, the front section 110 external battery may be used as a primary means to charge the HMD device, and the rear section 115 external battery may be used as a backup. The front section battery can be swapped out with the rear section battery when, for example, the front section battery is depleted or when the HMD device 105 notifies the user that the front section battery is running low.

Alternatively, the front and rear section external batteries may both be used to charge the HMD device. The internal circuitry of the HMD device may be configured to enable power from the external batteries to be retrieved and used by the HMD device simultaneously. Or, the internal circuitry may be configured to retrieve the power from the external batteries and power an internal battery, in which the internal battery powers the HMD device's components. Some combination of the scenarios is also possible.

Furthermore, multiple external batteries can be strung together, as shown by numeral 605. Each external battery can include a receptacle and contact point on opposing ends. The receptacles can be on a side opposite the connectors, which enables each external battery to string together for easier user handling and management. Furthermore, the user may string together multiple external batteries and use the end external batteries to connect to the receptacles on the temple ends.

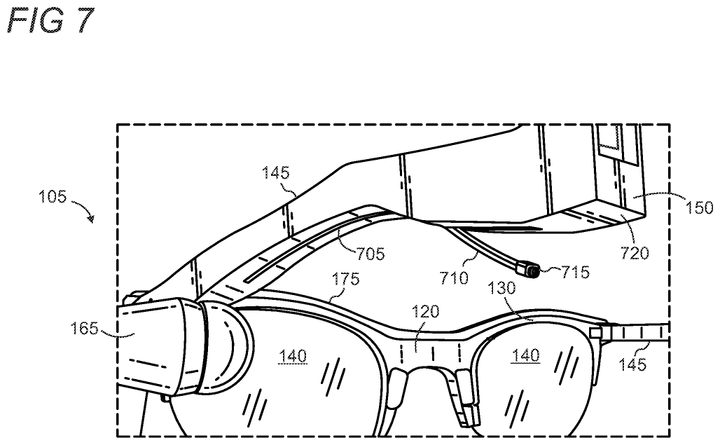

FIG. 7 shows an illustrative representation in which a bottom surface 720 of the temple 145 is adapted with a cavity 705 inside which a wire 710 and connector 715 are tucked away and stored. The cavity may have a spring-loaded mechanism therein that causes the wires to retract back into the cavity to provide a more comfortable user experience. The connector 715 may be a port that connects to, for example, an earbud 165. The port may be any one of a USB (universal serial bus), micro-USB, mini-USB, Type A or B, or other connecting types.

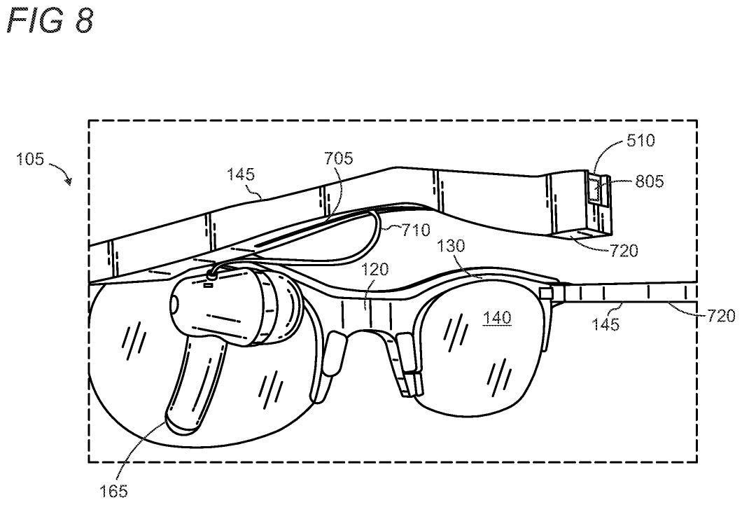

FIG. 8 shows an illustrative representation in which the connector 715 is plugged into the earbuds 165. The HMD device 105 may pull a charge from the external batteries to facilitate the transfer of energy from the external battery to the HMD device and into the earbuds. Thus, the external batteries can be used to facilitate all-day use of the HMD device and all-day use of peripheral devices to the HMD device (or another primary computing device, such as a smartwatch, smartphone, IoT (Internet of Things) device, etc.). When the earbuds are not connected to connector 715, the spring-loaded mechanism may tuck the wire back into cavity 705. A portion of the connector may also extend into the cavity, or the connector may dangle outside the cavity for easy user access.

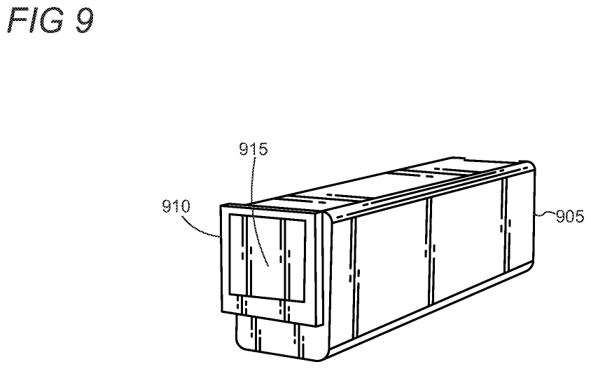

FIG. 9 shows an illustrative representation of an extender 905, equipped with a connector 910 and contact point 915. The extender can connect to the temple receptacles 510 of the HMD device 105 to accommodate differently shaped heads.

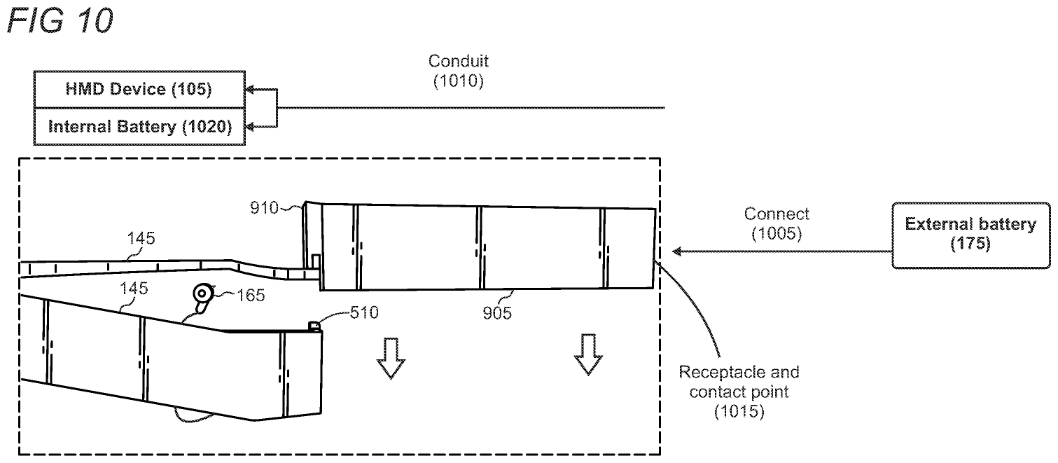

FIG. 10 shows an illustrative representation in which the extender 905 is aligned with the temple receptacle 510 for engagement. The extender's rear side includes a receptacle and contact point 1015 to which an external battery 175 can connect 1005, just as if the extender was not present for the external battery (i.e., the battery connected to the temple receptacles 510). Thus, the extenders function as a conduit 1010 to transfer energy between a connected external battery 175 and the HMD device 105 or an internal battery 1020.

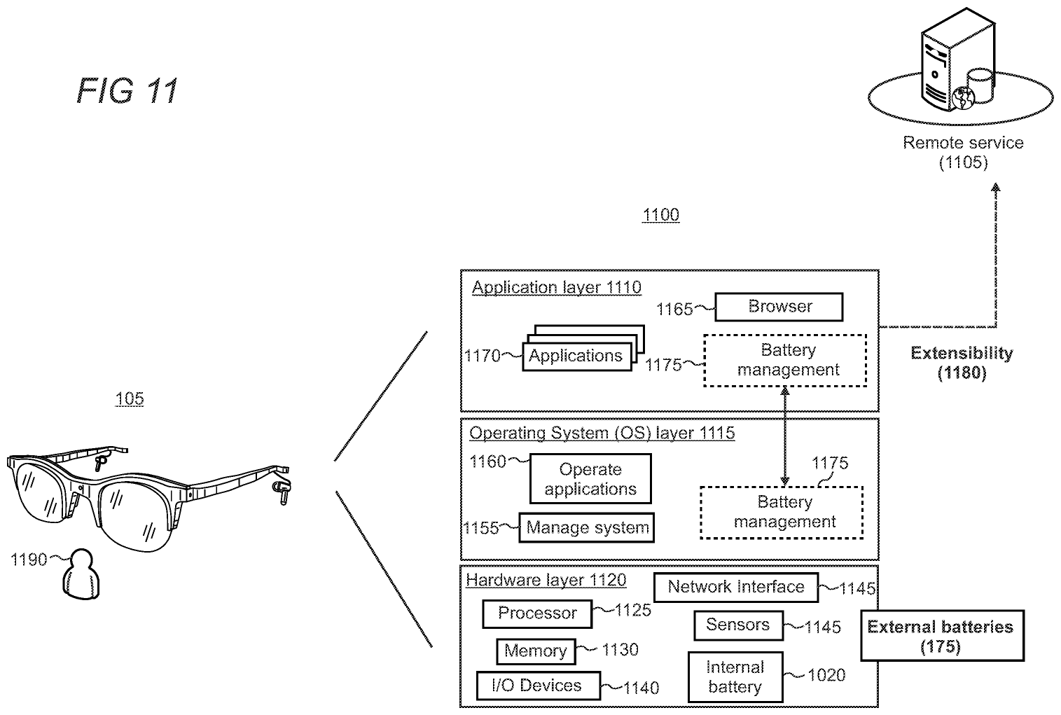

FIG. 11 shows an illustrative layered architecture 1100 of the HMD device 105, which may be used to implement the battery system described herein. The architecture may apply to, for example, computing devices operated by users, such as user 1190. While an HMD device is illustrated as the primary computing device on which the present external battery system can be implemented, other computing devices, such as those having an architecture shown FIG. 11, can also utilize the present system, including smartwatches, smartphones, tablet computers, IoT (Internet of Things) devices including refrigerators, toasters, sensory devices, etc. Thus, any reference to an HMD device is exemplary, and other devices may utilize similar technology.

The computing devices can include a hardware layer 1120, operating system (OS) layer 1115, and application layer 1110. The hardware layer 1115 provides an abstraction of the various hardware used by the computing device (e.g., input and output devices, networking and radio hardware, etc.) to the layers above it. In this illustrative example, the hardware layer supports processor(s) 1125, memory 1130, input/output devices 1140 (e.g., a microphone, speakers 550, camera, and headset). The computing device may likewise include a network interface 1145, such as a network interface card (NIC) that enables wired (e.g., Ethernet) or wireless communications to a router or other computing device. For example, one or more network interface devices may enable the transmission of WiFi signals to a router and be configured with Bluetooth® or NFC (Near Field Communication) capabilities.

The HMD device 105 may also include various sensors, such as LIDAR (Light Detection and Ranging), accelerometers, gyroscopes, etc. The computing device includes an internal battery 1020, which may be used as a primary battery source or a backup battery to the external battery 175. In one scenario, the HMD device may operate its components using energy pulled from the internal battery. The external battery may charge the internal battery to enable the internal battery to continue its capabilities. Alternatively, the HMD device may leverage the external battery as a primary means of power and utilize the internal battery when, for example, the external battery is being replaced or is depleted. The batteries may be rechargeable lithium-ion (Li-ion) batteries that can receive a charge for re-use.

The application layer 1110 in this illustrative example supports various applications 1170. A battery management application 1175 controls and manages the use of the internal and external batteries by the HMD device's internal system, and a web browser application 1165 to access the Internet and the World Wide Web. The HMD device has extensibility to remote services 1105, such as, for example, websites and other applications.

Although only certain applications are depicted in FIG. 5, any number of applications can be utilized by the HMD device 105. The applications are often implemented using locally executing code. However, in some cases, these applications can rely on services and/or remote code execution provided by remote servers or other computing platforms such as those supported by a service provider or other cloud-based resources.

The OS layer 1115 supports, among other operations, managing system 1155 and operating applications/programs 1160, and battery management 1175. The OS layer may interoperate with the application and hardware layers in order to perform various functions and features. In this regard, the battery management operations may be performed at the application layer 1110 or OS layer 1115 depending on a specific implementation or a combination of the two. For example, certain features, such as where the system pulls power from, may be controlled by the OS. In contrast, other features, such as presenting a notification to the user regarding a low battery, may be performed at the application layer.

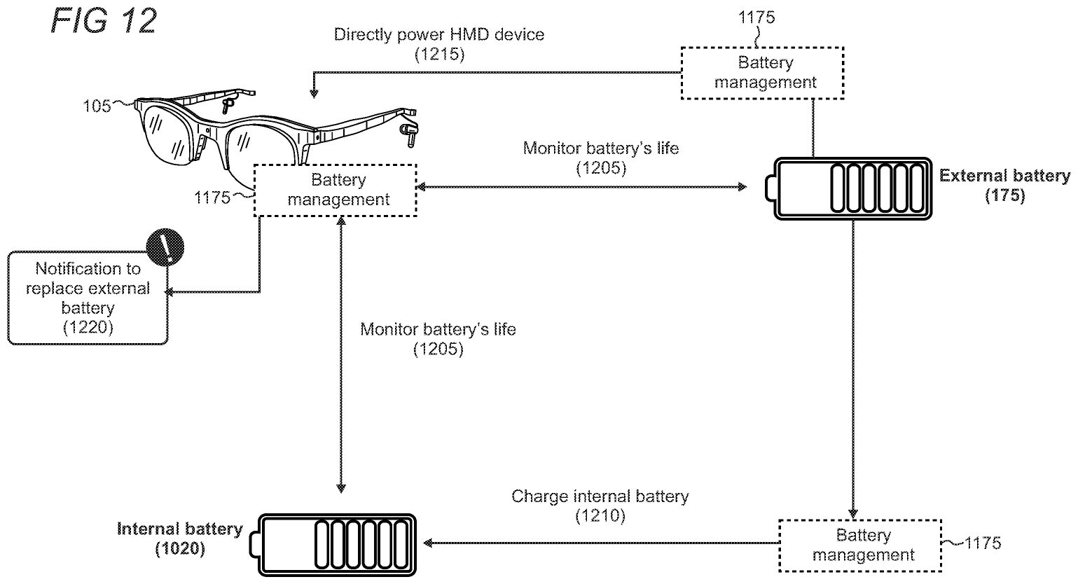

FIG. 12 shows an illustrative representation in which the battery management application 1175 controls and manages various features for the dual external-internal battery system. The application monitors the battery life 1205 associated with the external battery 175 and internal battery 1020. Monitoring can include identifying a percentage of battery left for the devices, identifying when a battery reaches a pre-set battery level threshold, and notifying the user accordingly, such as by presenting a notification on the lenses 140, as representatively shown by numeral 1220. The application may periodically retrieve a battery's status, including its health and current capacity.

The battery management application 1175 may additionally control how the external battery 175 is utilized. For example, in one scenario, a connected external battery may charge the internal battery 1210. In this scenario, the internal battery is the primary means of power for the HMD device, and the external battery is utilized to charge the internal battery.

In another scenario, the external battery 175 may directly power the HMD device 105 and its' functions. For example, the printed circuit board (PCB) can utilize the external battery and route energy to the various other hardware components, such as the processor, memory, etc. The HMD device may utilize the external battery's power and then switch to the internal battery 1020 when the external battery is depleted. The internal battery may be a secondary battery to the external battery, in this regard, or may be a primary battery that is being intelligently managed by the HMD device. That is, better to use the external battery before using the internal one.

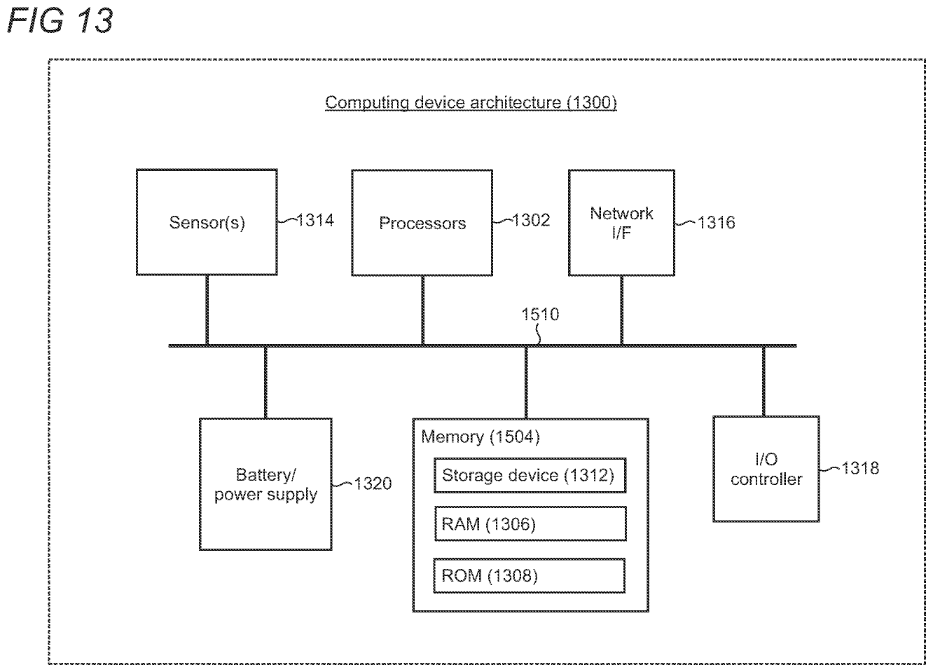

FIG. 13 shows an illustrative architecture 1300 for a device, such as an HMD device, IoT device, smartphone, or tablet capable of executing the various functions described herein. The architecture 1300 illustrated in FIG. 13 includes one or more processors 1302 (e.g., central processing unit, dedicated AI chip, graphics processing unit, etc.), a system memory 1304, including RAM (random access memory) 1306, ROM (read-only memory) 1308, and long-term storage devices 1312. The system bus 1310 operatively and functionally couples the components in the architecture 1300. A basic input/output system containing the basic routines that help to transfer information between elements within the architecture 1300, such as during startup, is typically stored in the ROM 1308. The architecture 1300 further includes a long-term storage device 1312 for storing software code or other computer-executed code that is utilized to implement applications, the file system, and the operating system. The storage device 1312 is connected to processor 1302 through a storage controller (not shown) connected to bus 1310. The storage device 1312 and its associated computer-readable storage media provide non-volatile storage for the architecture 1300. Although the description of computer-readable storage media contained herein refers to a long-term storage device, such as a hard disk or CD-ROM drive, it may be appreciated by those skilled in the art that computer-readable storage media can be any available storage media that can be accessed by the architecture 1300, including solid-state drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1300.

According to various embodiments, the architecture 1300 may operate in a networked environment using logical connections to remote computers through a network. The architecture 1300 may connect to the network through a network interface unit 1316 connected to the bus 1310. It may be appreciated that the network interface unit 1316 also may be utilized to connect to other types of networks and remote computer systems. The architecture 1300 also may include an input/output controller 1318 for receiving and processing input from a number of other devices, including a keyboard, mouse, touchpad, touchscreen, control devices such as buttons and switches or electronic stylus (not shown in FIG. 13). Similarly, the input/output controller 1318 may provide output to a display screen, user interface, a printer, or other type of output device (also not shown in FIG. 13).

It may be appreciated that any software components described herein may, when loaded into the processor 1302 and executed, transform the processor 1302 and the overall architecture 1300 from a general-purpose computing system into a special-purpose computing system customized to facilitate the functionality presented herein. The processor 1302 may be constructed from any number of transistors or other discrete circuit elements, which may individually or collectively assume any number of states. More specifically, processor 1302 may operate as a finite-state machine in response to executable instructions contained within the software modules disclosed herein. These computer-executable instructions may transform the processor 1302 by specifying how the processor 1302 transitions between states, thereby transforming the transistors or other discrete hardware elements constituting the processor 1302.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

Disclosed are various implementations of a head-mounted display device utilizing interchangeable external batteries. One embodiment includes a head-mounted display (HMD) device having electrical components, the HMD device comprising: a frame having a front section and a rear section, in which the frame includes: a lens frame that connects to a lens; a bridge positioned at a central part of the front section, the bridge adapted for resting on a nose of a user; and a left and right temple that extend generally perpendicular from the front section's frame and are adapted for resting on the user's left and right ears, respectively, wherein the frame includes a channel that hosts an external battery that is detachable from the channel, in which the channel includes a receptacle to which the external battery detachably connects.

In another example, the external battery has a form-factor that at least partially corresponds to a form-factor of the frame's channel. In another example, the external battery includes an outer housing and an interior battery positioned inside the outer housing, in which the interior battery likewise includes a form factor that at least partially corresponds to a form factor of the outer housing. In that example, the frame's channel includes a contact point to which a corresponding contact point on the external battery engages. As another example, the left and right temples include temple ends, and wherein the temple ends include respective receptacles to which covers engage to protect the temple end receptacles. In a further example, when the temple end covers are removed, the external battery's connectors detachably engage to the temple end receptacles as a holding place for the external battery. In a further example, the HMD device hosts two external batteries simultaneously—inside the frame's channel and at the temple end receptacles. As another example, the two external batteries have distinct color schemes. In another example, when the temple end covers are removed, detachable extenders engage with the temple end receptacles to extend the length of the temples to accommodate differently shaped heads for the HMD device, and wherein the external battery's connectors detachably engage to receptacles on the extenders. In a further example, the extenders include internal circuitry which enables the extender to function as a conduit through which energy from the external battery is relayed to the HMD device. Another example further comprises a cavity at a bottom surface of the left and right temples, inside which are respective charging cables. As another example, the charging cables connect to and charge earbuds, which in turn receive an electrical charge from the external battery. In a further example, the electrical components associated with the HMD device include: one or more processors; and one or more hardware-based memory devices storing computer-executable instructions which, when executed by the one or more processors, cause the HMD device to: provide a notification regarding a status of the external battery's charge; and notify the user to disengage and replace the external battery with a new external battery. As another example, the HMD device includes an internal battery within the frame, in which the internal battery stores a charge to power the HMD device while the external battery is removed or has a depleted charge. In that example, the HMD device directly utilizes the external battery's charge to power its electrical components. As a further example, the executed instructions further cause the HMD device to: utilize the external battery's charge to re-charge the internal battery; and utilize the internal battery to power the electrical components and the HMD device's functions.

In another exemplary embodiment, implemented is a computing device, comprising: a frame, in which the frame includes a receptacle inside a substantially linear channel, and inside the channel are contact points to communicate with a connected device; and a substantially linear external device that is connected to the receptacle inside the frame's channel, wherein the external device includes corresponding contact points that engage with the channel's contact points to pass data or a charge, wherein the channel has a bottom surface which an entire surface of the external device touches.

As a further example, the channel includes a generally perpendicular opening that receives a corresponding connector that generally protrudes perpendicular to the external device, a contact point being placed on the connector, and wherein the connector inserts into the channel's opening. Another example further comprises left and right temples which extend from a front section of the frame, and wherein the left and right temples have an opening and contact points that enable the linear external device to alternatively connect to the temple's receptacle. A further example comprises an internal battery inside of the computing device's frame, and wherein the external device provides an alternate power source to the internal battery for the computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A head-mounted display (HMD) device having electrical components, the HMD device comprising:
a frame having a front section and a rear section, in which the frame includes:
a lens frame that connects to a lens;
a bridge positioned at a central part of the front section, the bridge adapted for resting on a nose of a user; and
a left and right temple that extend generally perpendicular from the front section's frame and are adapted for resting on the user's left and right ears, respectively,
wherein the frame includes a channel that hosts an external battery that is detachable from the channel, in which the channel includes a receptacle to which the external battery detachably connects.

2. The HMD device of claim 1, wherein the external battery has a form-factor that at least partially corresponds to a form-factor of the frame's channel.

3. The HMD device of claim 2, wherein the external battery includes an outer housing and an interior battery positioned inside the outer housing, in which the interior battery likewise includes a form factor that at least partially corresponds to a form factor of the outer housing.

4. The HMD device of claim 3, wherein the frame's channel includes a contact point to which a corresponding contact point on the external battery engages.

5. The HMD device of claim 1, wherein the left and right temples include temple ends, and wherein the temple ends include respective receptacles to which covers engage to protect the temple end receptacles.

6. The HMD device of claim 5, wherein, when the temple end covers are removed, the external battery's connectors detachably engage to the temple end receptacles as a holding place for the external battery.

7. The HDM device of claim 6, wherein the HMD device hosts two external batteries simultaneously—inside the frame's channel and at the temple end receptacles.

8. The HMD device of claim 7, wherein the two external batteries have distinct color schemes.

9. The HMD device of claim 5, wherein, when the temple end covers are removed, detachable extenders engage with the temple end receptacles to extend the length of the temples to accommodate differently shaped heads for the HMD device, and wherein the external battery's connectors detachably engage to receptacles on the extenders.

10. The HMD device of claim 9, wherein the extenders include internal circuitry which enables the extender to function as a conduit through which energy from the external battery is relayed to the HMD device.

11. The HMD device of claim 1, further comprising a cavity at a bottom surface of the left and right temples, inside which are respective charging cables.

12. The HMD device of claim 11, wherein the charging cables connect to and charge earbuds, which in turn receive an electrical charge from the external battery.

13. The HMD device of claim 1, wherein the electrical components associated with the HMD device include:
one or more processors; and
one or more hardware-based memory devices storing computer-executable instructions which, when executed by the one or more processors, cause the HMD device to:
provide a notification regarding a status of the external battery's charge; and
notify the user to disengage and replace the external battery with a new external battery.

14. The HMD device of claim 13, wherein the HMD device includes an internal battery within the frame, in which the internal battery stores a charge to power the HMD device while the external battery is removed or has a depleted charge.

15. The HMD device of claim 14, wherein the HMD device directly utilizes the external battery's charge to power its electrical components.

16. The HMD device of claim 14, wherein the executed instructions further cause the HMD device to:
utilize the external battery's charge to re-charge the internal battery; and
utilize the internal battery to power the electrical components and the HMD device's functions.

17. A computing device, comprising:
a frame, in which the frame includes a receptacle inside a substantially linear channel, and inside the channel are contact points to communicate with a connected device; and
a substantially linear external device that is connected to the receptacle inside the frame's channel, wherein the external device includes corresponding contact points that engage with the channel's contact points to pass data or a charge, wherein the channel has a bottom surface which an entire surface of the external device touches.

18. The computing device of claim 17, wherein the channel includes a generally perpendicular opening that receives a corresponding connector that generally protrudes perpendicular to the external device, a contact point being placed on the connector, and wherein the connector inserts into the channel's opening.

19. The computing device of claim 17, further comprising left and right temples which extend from a front section of the frame, and wherein the left and right temples have an opening and contact points that enable the linear external device to alternatively connect to the temple's receptacle.

20. The computing device of claim 17, further comprising an internal battery inside of the computing device's frame, and wherein the external device provides an alternate power source to the internal battery for the computing device.
